(19) United States
(12) Patent Application Publication
(10) Pub. No.: US 2005/0005455 A1
(43) Pub. Date: Jan. 13, 2005

(54) Device for cuttng through a bindng strip

(75) Inventors: Johan Spaans, Noord-Scharwoude (NL); Hendrikus Wilhelmus Maria Olivier, Heerhugowaard (NL); Johannes Gerardus Liefting, Alkmaar (NL)

Correspondence Address: NORMAN H. ZIVIN;Cooper & Dunham LLP, 1185 Avenue of the Americas, New York, NY, 10036, US

(73) Assignee: Tebulo Industrial Automation B.V.

(21) Appl. No.: 10/886,092

(22) Filed: Jul. 6, 2004

(30) Foreign Application Priority Data
Jul. 10, 2003 (NL) 1023884

(51) Int. Cl. B26B 15/00

(52) U.S. Cl. 30/228

(57) ABSTRACT

A device for parting a strip (6) of binding material that has been fitted around an article (5), such as a roll of sheet material or bundle of sections and the like, comprising a housing (1) provided with a support (12) for supporting the device with respect to the article (5), two blades (7, 8) connected to the housing (1), at least one blade (8) of which can be moved with respect to the housing (1), drive means (10) for moving the blades with respect to one another between an open position and a closed position for cutting through and/or snipping through the strip (6) when the housing (1) is bearing on the article, and a clamp (16) for holding the parted strip. The clamp (16) and one of the blades can be brought into interaction with one another to clamp the strip (6) between them.

The invention relates to a device for parting a strip of binding material that has been fitted around an article, such as a roll of sheet material or bundle of sections and the like, comprising a housing provided with a support for supporting the device with respect to the article, two blades connected to the housing, at least one blade of which can be moved with respect to the housing, drive means for moving the blades with respect to one another between an open position and a closed position for cutting through and/or snipping through the strip when the housing is bearing on the article, and a clamp for holding the parted strip.

A device of this type is disclosed in EP-A 945 351. In this known device a clamping plate is arranged alongside a movable blade, which clamping plate must ensure, together with an opposing plate rigidly mounted on the housing, that the strip does not fly off under the influence of the pretension therein once it has been cut through. If the pretension in the strip is on the high side, the strip can, however, suddenly rupture completely right at the start of the snipping or cutting operation. The consequence of this can be that the strip ruptured in this way nevertheless flies off because the clamp has not yet been able to grip the strip properly.

The aim of the invention is to provide a device of the abovementioned type with which flying off of the strip can be better prevented Said aim is achieved in that the clamp and one of the blades can be brought into interaction with one another to clamp the strip between them.

With the device according to the invention it can be guaranteed that the strip is reliably clamped between the clamp and the movable blade. Only then is the definitive cutting or snipping operation carried out.

It is known to make one blade movable with respect to the housing and the other fixed. According to the invention with this arrangement the clamp is accommodated in the housing such that the movable blade comes into interaction therewith during its movement, but before the actual cutting or snipping operation between said movable blade and the fixed blade takes place.

It is furthermore known to provide restraining means on the housing to restrain the strip while the movable blade moves against it. The function of said restraining means is to prevent the trip being pushed along by the movable blade without a cutting or snipping action being obtained. This is important if the fixed blade has a cutting edge that runs in the direction of movement of the movable blade and thus is not able to provide any resting effect itself. According to the invention the restraining means comprise two restrainers that, transversely to the direction of movement of the blade, are some distance apart such that the movable blade can be moved between them. One of the restrainers can move with respect to the housing, transversely to the support, such that it is possible to take into account a more or less severely curved shape of the strip around the article,

The clamp can be held pressed into the housing under spring pretension, such that when the strip is clamped the clamp can be moved against the spring pretension. Preferably, the clamp and the blade have correspondingly oriented and/or shaped surfaces for clamping the strip between them. The cutting edge of the movable blade is defined by a cutting face that can be slid along a corresponding cutting face of the other blade, as well as a stop face that runs transversely thereto and can be slid along and in contact with a corresponding stop face of the clamp. The strip can be reliably clamped between these stop faces, in particular if the movable blade has a bearing face on the side facing the support and the stop face runs at an acute angle with respect to the bearing face.

To further enhance a reliable retaining action on the strip that has been cut through or snipped through, a pressure foot which is located alongside the clamp can additionally be provided, which pressure foot is designed to provide the effect of pressing the strip against the article. In addition, it is possible that the pressure foot can be pressed against the strip under spring pretension. The pressure foot is preferably on the same side of the blades as the clamp. This ensures that in any event one end of the strip can be reliably held even if the clamp should fail for whatever reason.

The housing can be joined by means of a spring suspension to a cap that has means for fixing the latter to a robot arm and the like. In that case even if the robot arm were unable to follow an imprecise surface of the article satisfactorily, the housing can nevertheless make contact with the article and the strip in the correct manner. In this context it is also advantageous if the housing has resilient supporting means on the support side for engaging on the article.

The invention will be explained in more detail below with reference to an illustrative embodiment of the device according to the invention shown in the figures.

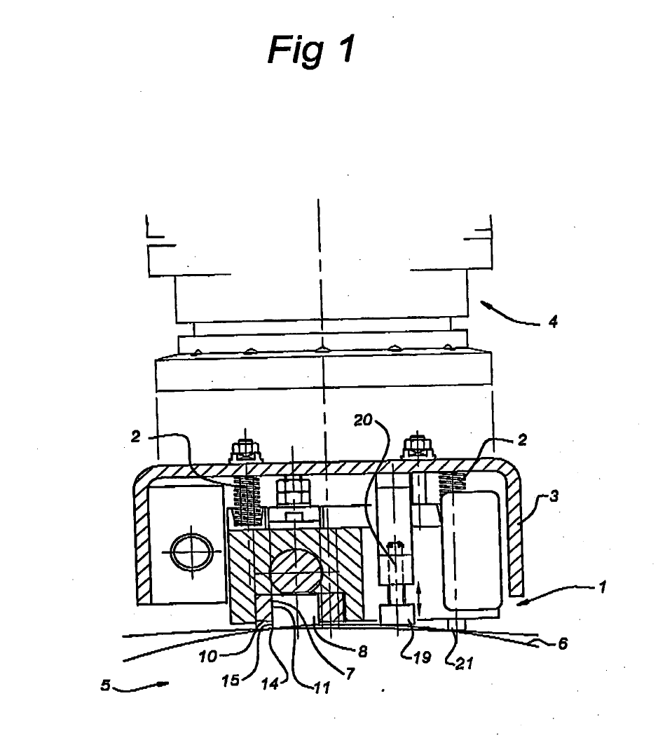

The device shown in FIGS. 1-3 comprises a housing 1 that is suspended by means of springs 2 from a cap 3. This cap 3 is attached to the end of a robot arm 4 that is known per se, is not shown in more detail and by means of which the device can be manipulated in the desired manner relative to the article 5. This article 5 is a roll of sheet material that is kept in the rolled-up state by means of a strip of binding material 6.

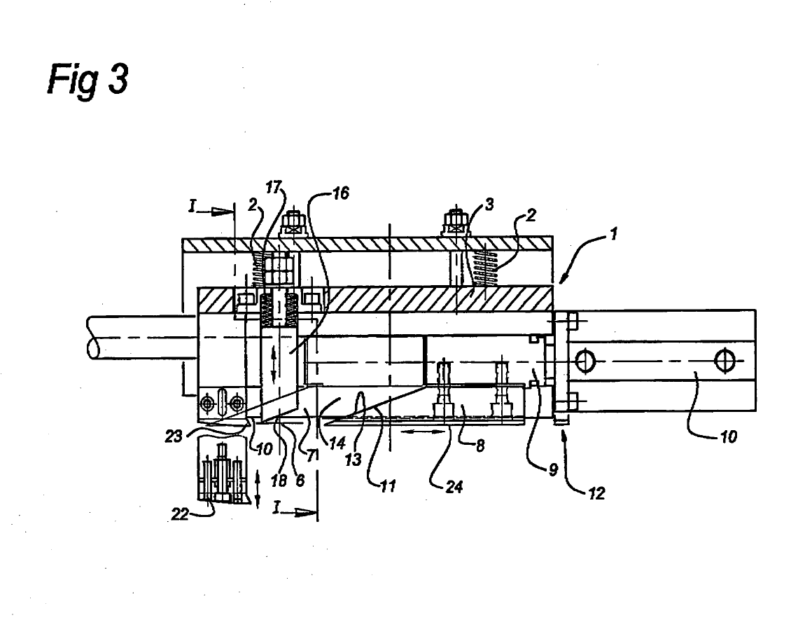

The housing 1 has a fixed blade 7 as well as a movable blade 8 that is mounted on the guide 9. The movable blade 8 can be moved back and forth by means of the drive 10 between the retracted position, shown by continuous lines in FIG. 3, and the position in which it has been moved forward, shown by broken lines. In the position in which it has been moved forward, the cutting edge 10 of the fixed blade 7 and the cutting edge 11 of the movable blade 8 have moved along one another, dog which movement the strip 6 is cut through. As can be seen in FIG. 3, the cutting edge 10 of the fixed blade 7 is essentially horizontal, that is to say parallel to the bearing face 12, whilst the cuffing edge 11 of the movable blade 8 runs obliquely and is at an acute angle to the bearing face 12.

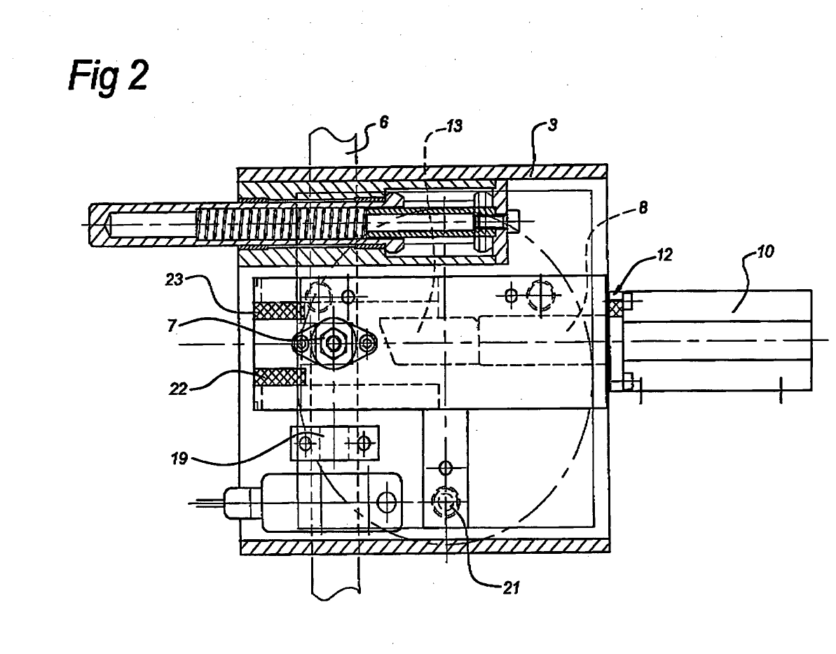

In the plan view in FIG. 2, in which the movable blade is shown in the retracted position by broken lines, it can be seen that the blade 8 has a top surface 13. This top surface 13 likewise runs obliquely, analogously to the cutting edge 11. The cutting edge 11 is thus defined by the face 13 running obliquely upwards and the cutting face 14. This cutting ace 14 of the movable blade can be moved along the cutting face 15 of the fixed blade 7.

When snipping through or cutting through the strip 6 by means of the blades 7, 8, it is best to hold the ends of the strip 6 firmly to prevent flying off. To this end the clamp 16 is provided in the housing which clamp 16 is held resiliently pressed towards the strip 6 under pretension of the spring 17. The clamp 16 has a lower surface 18 that is shaped correspondingly and runs parallel to the top surface 13 of the movable blade S. As soon as this blade 8 is moved forwards, towards the strip 6, the latter is clamped between the correspondingly shaped faces 13, 18 of the blade 8 and the clamp 16, such that the strip is secured against flying off. The strip is then cut through as the movement of the blade 8 progresses further.

The pressure foot 19 is provided as a further security measure to prevent the cut through strip 6 from flying off. This pressure foot is located transversely alongside the clamp 16, above the strip 6, as can also clearly be seen in FIGS. 1 and 2. The pressure foot is pressed towards the strip 6 under pretension of the spring 20. This means that when the housing 1 is brought into contact with the article 5 the pressure foot 19 is already pressed, under resilient pretension, against the strip 6 that has not yet been cut through. If, for whatever reason, for example as a consequence of a very high pretension in the strip 6, the latter is not reliably gripped by the faces 13, 18 of the blade 8 and the clamp 16, it is nevertheless ensured that the strip 6 is held clamped between the pressure foot 19 and the article 5.

The housing 1 furthermore has resilient supports 21, with a pin 22 that is in contact with the article 5 under resilient pretension. By this means it is always ensured that the housing 1 is positioned correctly with respect to the article 5 and the strip 6, even if the position by the robot arm 4 is less precise.

Finally, the housing has two restrainers 22, 23. The purpose of these is to restrain the strip 6 should this be displaced when the movable blade 8 moves. The strip 6 then comes into contact with the faces of the restrainers 22, 23 running obliquely upwards.

The one restrainer 23 is fixed with respect to the housing 1, such that it can always be held pressed against the article 5. The other restrainer 22, which in FIG. 3 is shown both in the retracted and in the protruding position, can be moved transversely with respect to the support 12. The movable restrainer 22 is under sprig pretension, such that it is always ensured that both restrainers 22, 23 are in contact with the article 5, irrespective of the curvature thereof.

1. Device for parting a strip (6) of binding material that has been fitted around an article (5), such as a roll of sheet material of bundle of sections and the like, comprising a housing (1) provided with a support (12) for supporting the device with respect to the article (5), two blades (7, 8) connected to the housing (1), at least one blade (8) of which can be moved with respect to the housing (1), drive means (10) for moving the blades with respect to one another between an open position and a closed position for cutting through and/or snipping through the strip (6) when the housing (1) is bearing on the article, and a clamp (16) for holding the parted strip, characterized in that the clamp (16) and one of the blades can be brought into interaction with one another to clamp the strip (6) between them.

2-14. (canceled).

15. Device according to claim 1, having a blade that can be moved with respect to the housing, wherein the clamp is accommodated in the housing.

16. Device according to claim 1, wherein the one blade (8) is fixed with respect to the housing (1) and the cutting edges (10, 11) of both blades (7, 8) are at an acute angle with respect to one another.

17. Device according to claim 1, having restraining means (22, 23) for restraining the strip (6) while the moveable blade moves into contact with the latter, wherein the restraining means comprises two restrainers (22, 23) that are spaced apart such that the moveable blade (8) can be moved between them.

18. Device according to claim 17, wherein one of the restraining means (22) can move with respect to the housing (1) transversely to the support (12).

19. Device according to claim 1, wherein the clamp (16) is held under pretension pressed into housing (1), such that when clamping the strip (6) the clamp (16) can be moved against the spring pretension.

20. Device according to claim 1, wherein the clamp (16) and the moveable blade (8) have correspondingly oriented and/or shaped surfaces (13, 18) for clamping the strip (6) between them.

21. Device according to claim 1, wherein a cutting edge (11) of the moveable blade (8) is defined by a cutting face (15) that can be slid along a corresponding cutting face (14) of the other blade (7), as well as a stop face (13) that runs transversely thereto and can be slid along and in contact with a corresponding stop face (18) of the clamp (16).

22. Device according to claim 21, wherein the moveable blade (8) has a bearing face (24) on the side facing the support (12) and the stop face (13) thereof runs at an acute angle with respect to the bearing face (24).

23. Device according to claim 1, wherein a pressure foot (19) which is located alongside the clamp (16) is provided, which pressure foot (19) is designed to provide the effect of pressing the strip (6) against the article (5).

24. Device according to claim 23, wherein the pressure foot (19) can be pressed against the strip (6) under spring pretension.

25. Device according to claim 23, wherein the pressure foot (19) is on the same side of the blades (7, 8) as the clamp (16).

26. Device according to claim 1, wherein the housing (1) is joined by means of a spring suspension (2) to a cap (3) that has means for fixing the latter to a robot arm (4).

27. Device according to claim 1, wherein the housing (1) has resilient supporting means (21) on the support (12) side for engaging on the article (5).
